(19) United States
(12) Patent Application Publication
(10) Pub. No.: US 2008/0123063 A1
(43) Pub. Date: May 29, 2008

(54) ADJUSTMENT METHOD FOR AN IMAGE-PROJECTION DISPLAY DEVICE

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/770,850

(22) Filed: Jun. 29, 2007

(30) Foreign Application Priority Data
Jun. 30, 2006 (JP) 2006-181209

(51) Int. Cl. G02B 27/62

(52) U.S. Cl. 353/121

(57) ABSTRACT

An adjustment method for an image-projection display device, in which an image-projection optical unit, a flat screen, and a mirror are provided, and with the method a bundle of light rays emitted from the image-projection optical unit is bent by the mirror so that a principal light ray, of a bundle of light rays being incident on the center of the flat screen, is made incident on the flat screen at an oblique angle; and

the adjustment method comprising steps of,
moving one of the image-projection optical unit in the direction orthogonal to the flat screen and the mirror in at least a direction parallel to the flat screen or a direction orthogonal to the flat screen; and
moving the other of the image-projection optical unit in the direction orthogonal to the flat screen and the mirror in at least a direction parallel to the flat screen or a direction orthogonal to the flat screen;

whereby a projection distance between the image-projection optical unit and the flat screen is adjusted without varying the position and direction of the principal light ray before and after adjustment.

### BACKGROUND OF THE INVENTION

1. Field of the Invention

The present invention relates to an image-projection display device (rear projection television), and in particular, relates to an adjustment method for adjusting an image on a display screen of the image-projection display device in an assembly process thereof.

2. Description of the Prior Art

An image-projection display device (rear projection television) projects a bundle of image-carrying light rays (hereinafter, a bundle of light rays) emitted from an image-projection optical unit onto a screen to be viewed as an image. For the purpose of miniaturizing an image-projection display device, and of reducing the size thereof in the optical axis direction (thinning), a bundle of light rays emitted from the image-projection optical unit is bent by reflection so that the bundle of light rays is made incident on the screen at an oblique angle (not a right angle). In the present patent application, this type of projection is defined as an oblique-projection by which the principal light ray of a bundle of light rays incident on the center of the flat screen is incident thereon at an oblique angle (not a right angle).

In such an image-projection display device of an oblique-projection type, the optical axis of the image-projection optical unit is not normal (orthogonal) to the screen. Therefore when a focus adjustment is carried out at the time of assembly (which is separate from a projection-distance adjustment, and is separate from a focusing adjustment mechanism provided in the image-projection optical unit), the image-projection optical unit itself has to be moved in an up-to-down direction (vertical direction) along the principal ray of a bundle of light rays which is progressing toward the center of the screen.

However, the image-projection optical unit has a certain amount of weights so that it is mechanically difficult to move the image-projection optical unit in a direction other than a horizontal direction (e.g., a vertical direction).

### SUMMARY OF THE INVENTION

The present invention provides an adjustment method for an image-projection display device which can perform a focus adjustment (projection-distance adjustment) through movement of the image-projection optical unit only in the horizontal direction without moving the same in the vertical direction.

The present invention is devised based on the following confirmed by the inventor:

By coordinating a step of moving the image-projection optical unit in the direction orthogonal to the screen, and a step of moving a mirror in at least a direction parallel to the screen or a direction orthogonal to the screen, a focus adjustment can be carried out even in a rear projection television of an oblique-projection type.

According to an aspect of the present invention, there is provided an adjustment method for an image-projection display device, in which an image-projection optical unit, a flat screen, and a mirror are provided, and with the method, a bundle of light rays emitted from the image-projection optical unit is bent by the mirror so that a principal light ray, of a bundle of light rays being incident on the center of the flat screen, is made incident on the flat screen at an oblique angle; and

The adjustment method comprising steps of,
moving one of the image-projection optical unit in the direction orthogonal to the flat screen and the mirror in at least a direction parallel to the flat screen or a direction orthogonal to the flat screen; and
moving the other of the image-projection optical unit in the direction orthogonal to the flat screen and the mirror in at least a direction parallel to the flat screen or a direction orthogonal to the flat screen;

whereby a projection distance between the image-projection optical unit and the flat screen is adjusted without varying the position and direction of the principal light ray before and after adjustment.

Furthermore, in the case where the area of the mirror is sufficiently large, even if the mirror is moved in a non-orthogonal (non-parallel) direction with respect to the flat screen, the movement of the mirror substantially contains a moving-component thereof in the orthogonal (parallel) direction with respect to the flat screen.

The traveling distances of the image-projection optical unit and the mirror for the purpose of adjusting the above-described positional relations thereof could be determined in a trial-and-error manner.

Here, on the other hand, the traveling distances of the image-projection optical unit and the mirror in the case where the both are moved in a direction orthogonal to the flat screen are quantitatively defined as follows:

the image-projection optical unit is moved in a direction orthogonal to the flat screen according to a first condition the image-projection optical unit is moved in a direction orthogonal to the flat screen according to a first condition:

1/tan(ω+2γ)−1/tan ω;

the mirror is moved in the direction orthogonal to the flat screen according to a second condition:

1/tan(ω+2γ)−1/tan β;

the traveling distance of the image-projection optical unit and the traveling distance of the mirror are determined to maintain the ratio of the first condition to the second condition; and

wherein

β(°) designates an angle between the mirror and a normal on the flat screen;

ω(°) designates an angle between the principal light ray of the bundle of light rays that runs from the image-projection optical unit to the mirror and the normal on the flat screen, the principal light ray of which is to be incident on the center of the flat screen at an oblique angle; and

γ(°) designates a reflection angle of the principal light ray with respect to the mirror, and defined as 90°-ω-β.

In addition, the traveling distances of the image-projection optical unit and the mirror in the case where the image-projection optical unit is moved in a direction orthogonal to the flat screen, and the mirror is moved in a direction parallel to the flat screen, are quantitatively defined as follows:

the image-projection optical unit is moved in a direction orthogonal to the flat screen according to the first condition:

1/tan(ω+2γ)−1/tan ω; (1)

the mirror is moved in the direction parallel to the flat screen according to a third condition:

1/tan β((1/tan)(ω+2γ)−1/tan β) (3)

the traveling distance of the image-projection optical unit and the traveling distance of the mirror are determined to maintain the ratio of the first condition to the third condition (ratio (a)); and

wherein

β(°) designates an angle between the mirror and a normal on the flat screen;

ω(°) designates an angle between the principal light ray of the bundle of light rays that runs from the image-projection optical unit to the mirror and the normal on the flat screen, the principal light ray of which is to be incident on the center of the flat screen at an oblique angle; and

γ(°) designates a reflection angle of the principal light ray with respect to the mirror, and defined as 90°-ω-β.

Between the mirror and the flat screen, a fixed mirror which is arranged to reflect the bundle of light rays having been reflected by the mirror to the flat screen is preferably provided, in order to reduce the size of the image-projection display device in the optical axis direction (thinning).

The present disclosure relates to subject matter contained in Japanese Patent Application No. 2006-181209 (filed on Jun. 30, 2006) which is expressly incorporated herein in its entirety.

### BRIEF DESCRIPTION OF THE DRAWINGS

The present invention will be discussed below in detail with reference to the accompanying drawings, in which:

FIG. 1 is a conceptual view illustrating an adjustment method for an image-projection display device, according to the present invention;

FIG. 2 is a conceptual view illustrating the principle of the adjustment method shown in FIG. 1; and

FIG. 3 is a partially enlarged view of FIG. 2.

### DESCRIPTION OF THE PREFERRED EMBODIMENTS

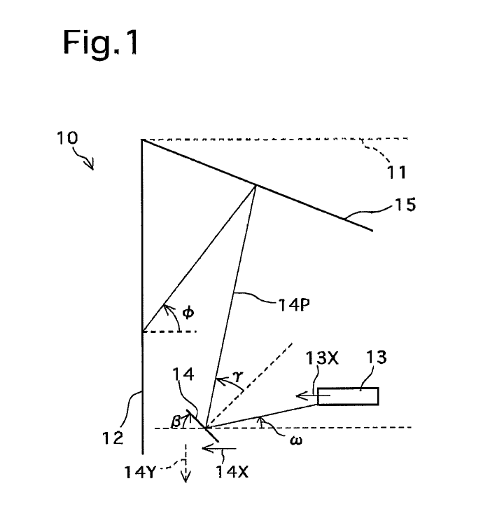

FIG. 1 is the conceptual view illustrating an adjustment method for an oblique-projection type image-projection display device (rear projection television) 10, to be carried out during assembly thereof.

The image-projection display device 10 is provided with, in a body 11 thereof, a flat screen 12 on a side of the body 11, an image-projection optical unit (image engine) 13, a small mirror 14 (a mirror), and a fixed mirror 15.

A bundle of image-carrying light rays (hereinafter, a bundle of light rays) emitted from the image-projection optical unit 13 is reflected by the small mirror 14. Thereafter, the bundle of light rays is incident on the fixed mirror 15, and is reflected toward the flat screen 12. Finally, the bundle of light rays is incident on the flat screen 12 at an oblique angle.

A plurality of mirrors (i.e., more than two mirrors) may be provided between the image-projection optical unit 13 and the flat screen 12; however, it is essential that the bundle of light rays be incident on the flat screen 12 at an oblique angle (i.e., an angle other than being orthogonal thereto).

The small mirror 14 is arranged to be the closest mirror to the image-projection optical unit 13.

In the above described image-projection display device 10, focus adjustment is performed by moving the image-projection optical unit 13 in a direction 13X orthogonal to the flat screen 12, and moving the small mirror 14 either in a direction 14X orthogonal to the flat screen 12, or in a direction 14Y parallel to the flat screen 12. The above movements of the small mirror 14 are performed so that the principal light ray of the bundle of light rays before the reflection at the small mirror 14 and the principal light ray 14P of the bundle of light rays after the reflection thereat lie in the same (vertical) plane.

By appropriately setting the ratio of the traveling distance of the image-projection optical unit 13 to that of the small mirror 14, the distance between the image-projection optical unit 13 and the flat screen 12 can be adjusted without varying the position of the principal light ray 14P, and consequently, the position of the principal ray (i.e., the up-to-down position of the image) with respect to the flat screen 12 does not vary.

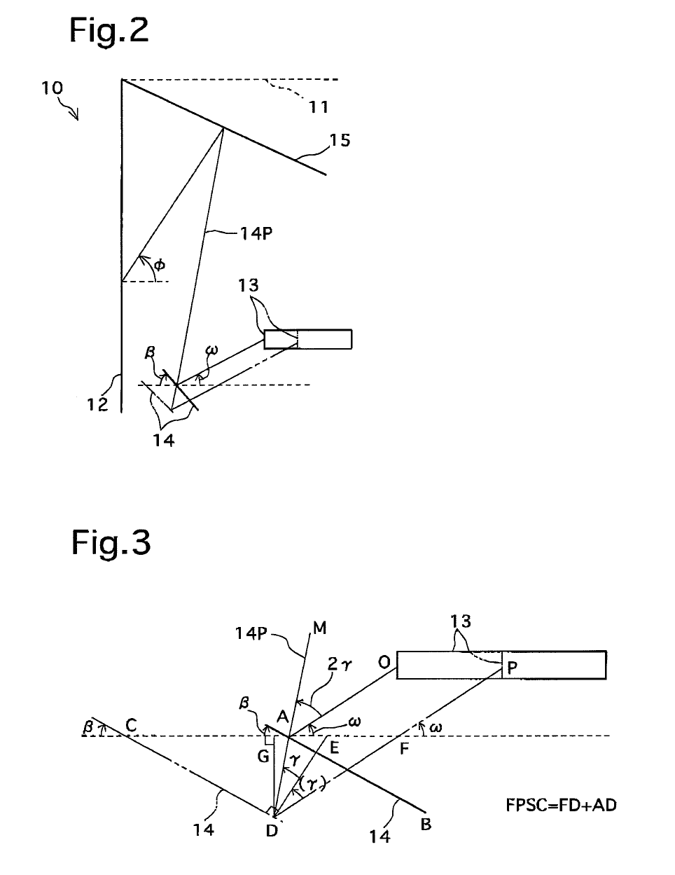

FIG. 2 is the conceptual view illustrating the principle of the adjustment method shown in FIG. 1. FIG. 3 is a partially enlarged view of FIG. 2.

In FIGS. 2 and 3, the positions In FIGS. 2 and 3, the positions of the image projection optical unit 13 and the small mirror 14 before adjustment are shown as solid lines, and the positions thereof after adjustment are shown as two-dot chain lines.

The image-projection optical unit 13 and the small mirror 14 are moved in the directions 13X and 14X, which are orthogonal to the flat screen 12, for the purpose of adjustment. After the adjustment, the image-projection optical unit 13 and the small mirror 14 are positioned so as not to vary the position of the principal light ray 14P of the bundle of light rays.

Here, the following variables are provided:

β(°): an angle between the small mirror 14 and a normal on the flat screen 12;

ω(°): an angle between the principal light ray of the bundle of light rays that runs from the image-projection optical unit 13 to the small mirror 14 and the normal on the flat screen 12, the principal light ray of which is to be incident on the center of the flat screen 12 at an oblique angle;

γ(°): a reflection angle of the principal light ray with respect to the small mirror 14, and defined as 90°-ω-β.

In FIGS. 1 to 3, the positive direction of each angle is indicated by the arrow mark. More specifically, the positive direction of the angles φ, ω and γ is counter clockwise with respect to each normal. On the other hand, the positive direction of the angle β is clockwise with respect to the normal on the flat screen 12.

The focal-point shift for correction (FPSC), i.e., the difference in optical paths length from the image-projection optical unit 13 to the flat screen 12 before and after the image projection optical unit 13 and the small mirror 14 are moved, can be obtained by the following condition:

FPSC=FD+AD=1/sin ω+1/sin(ω+2 γ) (F)

In order to satisfy condition (F), the image-projection optical unit 13 is moved by a distance AF (FIG. 3) in the direction 13X (FIG. 1) orthogonal to the flat screen 12, and the distance AF is obtained by a first condition:

AF=AG−FG=1/tan(ω+2γ)−1/tan ω (1)

Similarly, in order to satisfy condition (F), the small mirror 14 is moved by a distance AC of in the direction 14X (FIG. 1) orthogonal to the flat screen 12, and the distance AC (FIG. 3) is obtained by a second condition:

AC=AG+GC=1/tan(ω+2γ)+1/tan β (2)

In other words, the distance between the image-projection optical unit 13 and the flat screen 12 can be adjusted without varying the up-to-down position of the image on the flat screen 12 by moving the image-projection optical unit 13 and the small mirror 14 in a direction orthogonal to the flat screen 12 so that the following ratio (A) of the first condition (1) to the second condition (2) is satisfied:

AF:AC=1/tan(ω+2γ)−1/tan)−1/tan ω; 1/tan(ω+2 γ)+1/tan β (A)

As an alternative, the small mirror 14 can be moved in the direction 14Y (FIG. 1) parallel to the flat screen 12, instead of moving the small mirror 14 in the direction 14X.

More specifically, moving the small mirror 14 in the direction 14X by a unit-distance of “1”, is equivalent to moving the small mirror 14 in the direction 14Y by “1/tan β”. Accordingly, the traveling distance GD (FIG. 3) of the small mirror 14 in the direction 14Y is obtained by a third condition.

GD=tan β((1/tan(ω+2γ)+1/tan β) (3)

The distance between the image-projection optical unit 13 and the flat screen 12 can be adjusted without varying the up-to-down position the image on the flat screen 12 by moving the image-projection optical unit 13 in the direction 13X orthogonal to the flat screen 12, and by moving the small mirror 14 in the direction 14Y parallel to the flat screen 12 so that the following ratio (B) of the first condition (1) to the third condition (3) is satisfied:

AF:GD=1/tan(ω+2γ)−1/tanω: tan β((1/tan(ω+2γ)+1/tan β) (B)

For the adjustment, it is possible to move the image-projection optical unit 13 and the small mirror 14, in this order or a reversed order. Namely, the image-projection optical unit 13 and the small mirror 14 can be moved in any order. Further, it is also possible to move the image-projection optical unit 13 and the small mirror 14 simultaneously.

For moving the image-projection optical unit 13 and the small mirror 14,linear movement mechanisms, which are known in the art, can be used. For example, a feed-screw mechanism can be employed, in which the image-projection optical unit 13 and the small mirror 14 can be moved with the above-described ratios by controlling the rotational angle of the feed-screw of the feed-screw mechanism.

According to the embodiment, examples illustrating the focal-point shift for correction (FPSC), the traveling distance of the image-projection optical unit 13, and that of the small mirror 14 are hereinafter discussed.

In regard the directions 13X and 14X, moving toward the flat screen 12 is indicated as “+” (positive); and in regard to the direction 14Y, moving downward is indicated as “+” (positive).

### EXAMPLE 1

An angle φ between the principal light ray of the bundle of light rays and the normal on the flat screen 12=52.30°

ω=22.30°

β=38.00°

γ=29.70°

The focal-point shift for correction (FPSC) 10.00 mm

The traveling distance of the image-projection optical unit 13 in the direction 13X=−6.29 mm

The traveling distance of the small mirror 14 in the direction 14X=3.91 nm

### EXAMPLE 2

Under the same condition of Embodiment 1, the small mirror 14 is moved in the direction parallel to the flat screen 12.

φ=52.30°

ω=22.30°

β=38.00°

γ=29.70°

The focal-point shift for correction (FPSC)=10.00 mm

The traveling distance of the image-projection optical unit 13 in the direction 13X when the small mirror 14 is moved in the direction 14Y=−6.29 mm

The traveling distance of the small mirror 14 in the direction 14Y=3.06 mm

According to the above descriptions, in an image-projection display device having an oblique-projection type image-projection optical unit, by moving the image-projection optical unit 13 by a predetermined distance in the direction orthogonal to the flat screen 12 and the small mirror 14 by a predetermined distance in at least a direction parallel to the flat screen 12 or a direction orthogonal to the flat screen 12, a focus adjust (projection-distance adjustment), in an assembling process, can be performed.

What is claimed is:

1. An adjustment method for an image-projection display device, in which an image-projection optical unit, a flat screen, and a mirror are provided, and with said method a bundle of light rays emitted from said image-projection optical unit is bent by said mirror so that a principal light ray, of a bundle of light rays being incident on the center of said flat screen, is made incident on said flat screen at an oblique angle; and
said adjustment method comprising steps of,
moving one of said image-projection optical unit in the
direction orthogonal to said flat screen and said mirror in at least a direction parallel to said flat screen or a direction orthogonal to said flat screen; and
moving the other of said image-projection optical unit in the direction orthogonal to said flat screen and said mirror in at least a direction parallel to said flat screen or a direction orthogonal to said flat screen;
whereby a projection distance between said image-projection optical unit and said flat screen is adjusted without varying the position and direction of said principal light ray before and after adjustment.

2. The adjustment method for an image-projection display device according to claim 1, wherein said image-projection optical unit is moved in a direction orthogonal to said flat screen according to a first condition;
1/tan(ω+2γ)−1/tan ω;
wherein said mirror is moved in the direction orthogonal to said flat screen according to a second condition:
1/tan(ω+2γ)+1/tan β;
wherein the traveling distance of said image-projection optical unit and the traveling distance of said mirror are determined to maintain the ratio of said first condition to said second condition; and
wherein
β(°) designates an angle between said mirror and a normal on said flat screen;
ω(°) designates an angle between said principal light ray of said bundle of light rays that runs from said image-projection optical unit to said mirror and the normal on said flat screen, said principal light ray of which is to be incident on the center of said flat screen at an oblique angle; and
γ(°) designates a reflection angle of said principal light ray with respect to said mirror, and defined as 90°-ω-β.

3. The adjustment method for an image-projection display device according to claim 1, wherein said image-projection optical unit is moved in a direction orthogonal to said flat screen according to a first condition:
1/tan(ω+2γ)−1/tan ω;
wherein said mirror is moved in the direction parallel to said flat screen according to a third condition:
1/tan β((1/tan(ω+2γ)+1/tan β);
wherein the a traveling distance of said image-projection optical unit and the a traveling distance of said mirror is determined to maintain the ratio of said first condition to said third condition; and
wherein
β(°) designates an angle between said mirror and a normal on said flat screen;
ω(°) designates an angle between said principal light ray of said bundle of light rays that runs from said image-projection optical unit to said mirror and the normal on said flat screen, said principal light ray of which is to be incident on the center of said flat screen at an oblique angle; and
γ(°) designates a reflection angle of said principal light ray with respect to said mirror, and defined as 90°-ω-β.

4. The adjustment method for an image-projection display device according to claim 1, wherein said image-projection display device further comprises a fixed mirror that is arranged to reflect the bundle of light rays having been reflected by said mirror to said flat screen.
